(19) United States
(12) Patent Application Publication
(10) Pub. No.: US 2015/0083742 A1
(43) Pub. Date: Mar. 26, 2015

(54) APPARATUS FOR PROVIDING PILL

(71) Applicant: OHSUNG ELECTRONICS CO., LTD., Gyeongsangbuk-do (KR)

(72) Inventors: Un Ha CHOI, Buk-gu (KR); Bo Sung KANG, Gumi-si (KR)

(73) Assignee: OHSUNG ELECTRONICS CO., LTD., Gyeongsangbuk-do (KR)

(21) Appl. No.: 14/072,831

(22) Filed: Nov. 6, 2013

(30) Foreign Application Priority Data
Sep. 26, 2013 (KR) 10-2013-0114582

(51) Int. Cl. A61J 7/00; B65D 83/04

(52) U.S. Cl. CPC A61J 7/0076; B65D 83/04
USPC 221/7

(57) ABSTRACT

An apparatus is provided. The apparatus includes a body forming an external shape, a containing unit for containing a pill packet including pills to be taken, a driving assembly provided below the containing unit and applying a force for pushing the pill packet in one direction, a guide bar for providing a transfer path of the pill packet transferred by an operation of the driving assembly, an elevation bar provided above the guide bar and capable of descending or ascending toward the pill packet, a cylinder assembly for allowing the elevation bar to elevate, a discharge box for containing the pills when the pills are separated from the pill packet by the elevation bar, and a first outlet to be an opening of the discharge box.

### CROSS-REFERENCE TO RELATED APPLICATIONS

The present application claims priority under 35 U.S.C. 119 and 35 U.S.C. 365 to Korean Patent Application No. 10-2013-0114582 (filed on 26 Sep., 2013), which is hereby incorporated by reference in its entirety.

### BACKGROUND

The present disclosure relates to an apparatus for providing a packed pill, and more particularly, to an apparatus capable of discharging not only a packed pill but also a case for packing the pill.

Generally, patients periodically take medicines prescribed according to diagnosis results to cure diseases. Particularly, in the case of chronic patients having tuberculosis, diabetes, and high blood pressure, it is necessary to take a required dose at a required point in time due to properties of the diseases.

When patients having tuberculosis, diabetes, and high blood pressure do not take medicines at required points in time or take medicines less or more than required amounts, diseases thereof may worsen, and in severe cases, their lives may be endangered.

When a patient is old and his or her memory is deteriorated or is a feeble-minded person, these phenomena may frequently occur. Particularly, an overdose may cause a greater problem than a case of not taking medicines.

Generally, to overcome these limitations, caretakers or administrators for patients check medicine administration times and amounts one by one to directly help the patients taking medicines or to give notices to the patients in advance via communication devices.

### SUMMARY

Embodiments provide an apparatus for helping administration to allow a patient to take accurate kind and amount of medicine at a required point in time.

Embodiments also provide an apparatus for decreasing necessity of managing the apparatus by a medicine taker by allowing a wrapper for wrapping a pill or a packing case to be discharged through an additional outlet.

In one embodiment, an apparatus for providing a pill includes a body forming an external shape, a containing unit for containing a pill packet including pills to be taken, a driving assembly provided below the containing unit and applying a force for pushing the pill packet in one direction, a guide bar for providing a transfer path of the pill packet transferred by an operation of the driving assembly, an elevation bar provided above the guide bar and capable of descending or ascending toward the pill packet, a cylinder assembly for allowing the elevation bar to elevate, a discharge box for containing the pills when the pills are separated from the pill packet by the elevation bar, and a first outlet to be an opening of the discharge box.

By using the apparatus as described above, a user may receive a care with respect to taking pills remotely. Also, when taking a pill, it is unnecessary to have a trouble of throwing away a vacant pill packet after taking the pills.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating an environment, to which an apparatus for providing a pill according to an embodiment may be applied;

FIG. 2 is a view illustrating an external configuration of the apparatus of FIG. 1;

FIGS. 3 and 4 are views illustrating a containing unit, a driving assembly, and a cylinder assembly of the apparatus of FIG. 1; and

FIG. 5 is a block view illustrating the apparatus of FIG. 1.

### DETAILED DESCRIPTION OF THE EMBODIMENTS

Hereinafter, exemplary embodiments of the present invention will be described in detail with reference to the drawings.

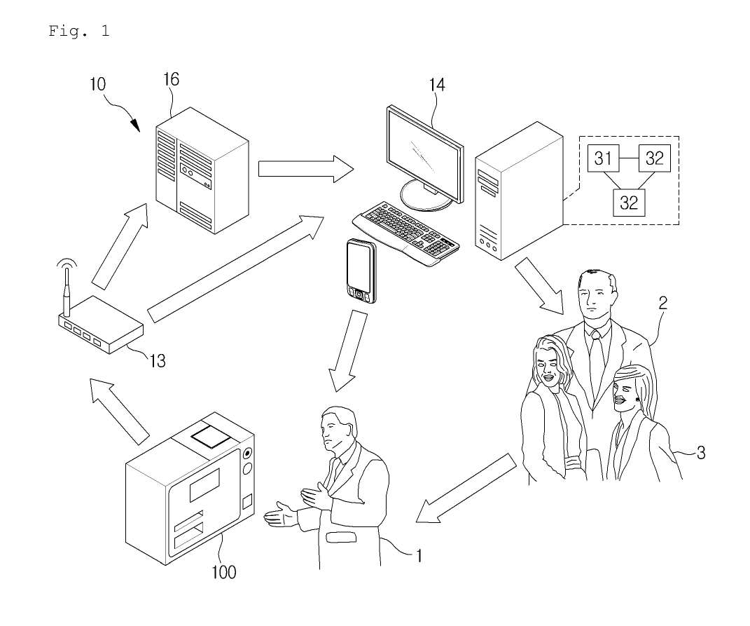

FIG. 1 is a view illustrating an environment, to which an apparatus 100 for providing a pill according to an embodiment may be applied.

As shown in FIG. 1, a processor 14 may be a personal computer or a mobile phone and may include a storage unit 31, an analysis processing unit 32, and a display unit 33. The processor 14 is connected to a reception device 13 on the wire or wirelessly such as via a local area network (LAN). Also, the processor 14 may be connected to the reception device 13 with a server 16 for storing data intervening therebetween. The storage unit 31 may be formed of a memory and is allowed to receive image information received from the reception device 13 directly or via the server 16 intervening therebetween.

Also, the analysis processing unit 32 may be configured to perform image-processing or all kinds of analyses with respect to image information stored in the storage unit 31. Also, although a plurality of pills whose kind is identical or a plurality of kinds of pills is received at the same time as image information, the analysis processing unit 32 may perform image-processing or all kinds of analyses with respect to the image information such as shapes or colors of the pills. The analysis processing unit 32 may be configured to distinguish the kind or number of the pills by using a database previously registered. The display unit 33 may be formed of a monitor and may be configured to display the image information stored in the storage unit 31 or processing results of the analysis processing unit 32.

Also, the apparatus 100 may be connected to the processor 14 via the reception device 13 or the server 16. Information of an image photographed by a camera provided in the apparatus 100 may be provided to the processor 14. In this case, the analysis processing unit 32 may check whether the photographed image corresponds to a pill what a user 1 should take. That is, through the apparatus 100, from which a designated amount of pills is discharged at a designated point in time, an image of a designated pill what the user 1 would like to take is photographed and the photographed image is transferred to the processor 14. Also, the processor 14 may determine whether the image corresponds to the pill what the user 1 using the apparatus 100 should take, by comparing with a database.

The processor 14 may refer to the database for personal data of the user 1, a kind, a number, and image information of pills to be taken, and an image of a face of the user 1, as information with respect to the apparatus 100. Accordingly, the analysis processing unit 32 of the processor 14 may determine whether the pill discharged from the apparatus 100 is correct or not. Information of a result of determining may be transferred to a doctor 2 or an expert 3. Alternatively, the processor 14 may send a warning message to the apparatus 100 by itself.

Accordingly, the apparatus 100 may include a module for transmitting and receiving data with the processor 14 via a network and may further include a camera for photographing an image of a face of a user or an image of a pill to be taken by the user.

Hereinafter, a configuration of the apparatus 100 will be described in more detail.

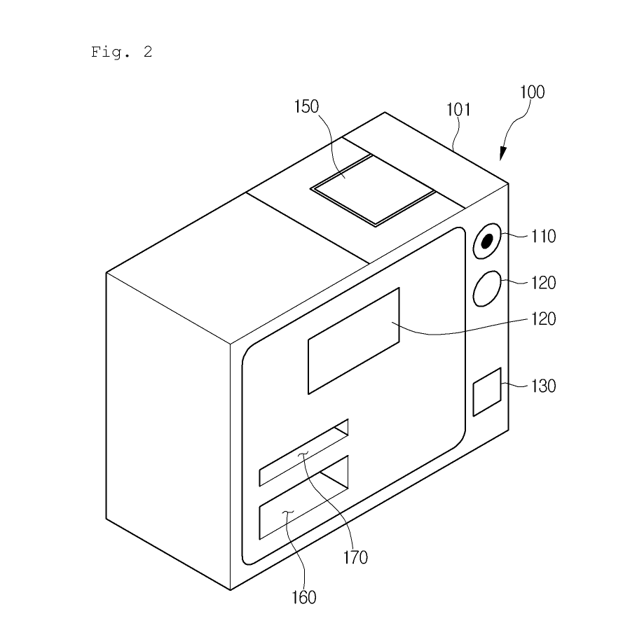

FIG. 2 is a view illustrating an external configuration of the apparatus 100.

Referring to FIG. 2, the apparatus 100 includes a body 101 forming an external shape, and the body 101 includes a pill packet insertion unit 150 for inserting a pill to be taken by a user.

Also, the apparatus 100 includes an operation unit 130 for operating the apparatus 100, a camera 110, a display unit 140 for displaying an operation status of the apparatus 100, a first outlet 160 through which the pill inserted through the pill packet insertion unit 150 is discharged, and a second outlet 170 through which a wrapper or a packing case for packing the pill is discharged. Also, the apparatus 100 may further include a speaker 120 for outputting an instruction message, a warning message, or a sound for informing the user of the operation status of the apparatus 100 or a point in time for taking a pill.

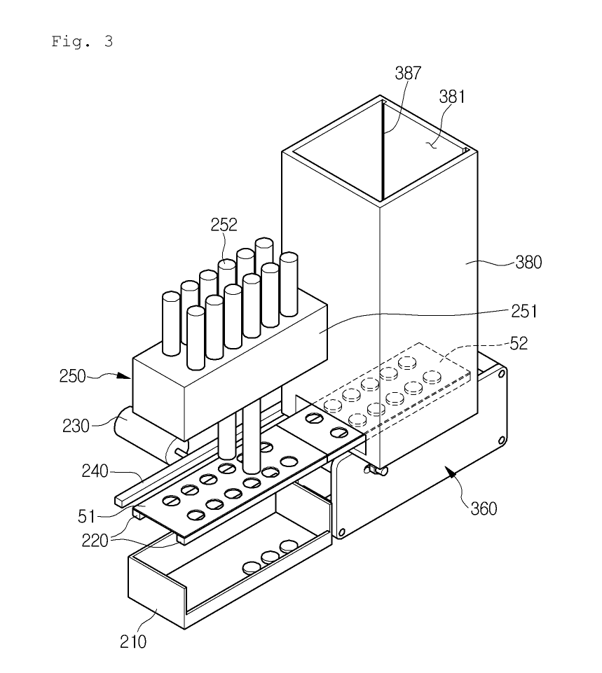

According to the embodiment, in addition to an outlet for discharging a pill to allow the user to take the pill, the apparatus 100 may further include an additional outlet for discharging a wrapper or a case for protecting the pill, which will be described in detail with reference to FIGS. 3 and 4.

Referring to FIG. 3, there are shown a containing unit 380 for containing a pill packet provided in the apparatus 100, a driving assembly 360 for transferring the contained pill packet toward a cylinder assembly 250, and the cylinder assembly 250 for separating a pill from wrapper of the transferred pill packet.

The containing unit 380 includes a storage part 381 providing a space for containing pill packets packed to allow a plurality of pills to have certain intervals and a guide groove 387 for guiding the pill packets downwardly while the pill packets are being stored. Also, the containing unit 380 includes an entrance 382 whose one side is open to allow the contained pill packets to be transferred by operation of the driving assembly 360. The entrance 382 of the containing unit 380 is connected to a plurality of guide bars 220, and the pill packet transferred along the guide bars 220.

Also, the driving assembly 360 applying a force to allow the contained pill packets to be transferred toward the cylinder assembly 250 along the guide bars 220 is mounted below the containing unit 380.

A configuration of the driving assembly 360 will be described with reference to FIG. 4.

The driving assembly 360 allows a push element 365 to be transferred forward and backward in such a way that the pill packets in the containing unit 380 are transferred by the push element 365.

In detail, the driving assembly 360 includes a motor unit 361 generating a driving force, a deceleration unit 362 reducing a rotation speed of the motor unit 361, a driving gear unit 363 connected to the deceleration unit 362, and a power transfer element 367 transferring a rotation force of the driving gear unit 363 to a driven gear unit 364.

When the driving force of the motor unit 361 is transferred to the driving gear unit 363 via the deceleration unit 362, the driving gear unit 363 rotates at a certain rotation speed.

When the driving gear unit 363 rotates, the driven gear unit 364 is rotated by the power transfer element 367. The driven gear unit 364 is disposed to be separated from the driving gear unit 363.

Also, the driving gear unit 363 and the driven gear unit 364 each may be formed of a plurality of gears, the gears being separated from one other. In this case, rotational axes may be coupled with the plurality of gears, respectively.

The power transfer element 367 may be a belt element covering outer circumferential surfaces of the driving gear unit 363 and driven gear unit 364, and more particularly, may be a timing belt for reliably transferring power. While the driving gear unit 363 and the driven gear unit 364 are rotating, the power transfer element 367 may be rotated while forming a certain tensile force.

In addition, on an outer circumferential surface of the power transfer element 367, a plurality of push elements 365 connected to the power transfer element 367 is provided. As an example, as shown in FIG. 4, the push element 365 is located in a center of the power transfer element 367.

When the power transfer element 367 is rotated, the push element 365 pushes a pill packet 370 toward the cylinder assembly 250. The pill packets 370 transferred as described above are transferred along the two guide bars 220. As a simple example, when pill packets are transferred while being in contact with one another, it is possible not to configure an additional transfer unit.

According to control of a control unit, the motor unit 361 generates the driving force and the driving force allows the power transfer element 367 to move. While, the power transfer element 367 is being rotated clockwise, the push element 365 may push the pill packet 370 in a direction W1.

Also, the driving assembly 360 further includes a switch 369 applying or blocking power depending on a transfer or progress of an object such as a limit switch or a micro switch.

The push element 365 pushes the pill packet 370, is continuously rotated, and arrives at the switch 369 in an upper portion of a rear of the driving assembly 360. The switch 369 is turned off due to continuous progress of the push element 365.

Then, the motor unit 361 stops driving and is on standby till the power is applied again by the control unit.

When the power is applied to the motor unit 361, the driving assembly 360 may operate. According thereto, the pill packet 370 may be transferred along the guide bars 220. A pill packet pushed by the push element 365 pushes another pill packet already disposed on the guide bars 220 and finally may be located under an elevation bar 253 of the cylinder assembly 250.

A configuration of the cylinder assembly 250 and a configuration for discharging not only a pill from a pill packet according to operations of the cylinder assembly 250 but also a vacant pill packet with all pills discharged will be described more.

The pill packet transferred along the guide bars 220 is located under the cylinder assembly 250. The cylinder assembly 250 includes a cylinder box 251 forming a body, driving cylinders 252 whose number is identical to pills included pill packets, and the elevation bars 253 elevating according to driving of the driving cylinders 252.

That is, the control unit of the apparatus 100 operates the driving cylinder 252 to selectively the elevation unit 253 disposed above each of pills to discharge a pill at a point in time of taking the pill. For this, the number and locations of the driving cylinders 252 may correspond to pills in pill packets. For example, a provider providing the apparatus 100 may allow pills to be packed according to a number and locations of provided driving cylinders and elevation bars. When the provider is a clinic or a pharmacy, packing pills may be performed according to the configuration of the apparatus 100.

As shown in the drawings, six driving cylinders 252 are provided in two rows as totally twelve and the elevation bars 253 elevated by the driving cylinders 252 are also provided as twelve. In this case, the control unit of the apparatus 100 may give a number to each of the driving cylinders 252 and may record the number of the driving cylinder 252 operating to discharge a pill. The driving cylinders 252 may operate in a predetermined order. Depending on the kind of a pill to be taken, it is necessary to discharge a plurality of pills or to discharge a different number of pills. In this case, the number of the driving cylinder 252 that operates is stored.

The elevation bar 253 strongly pushes a pill contained in a pill packet to be dropped to a discharge box 210. A length of the elevation bar 253 and a transfer distance thereof during elevation may be variously changed depending on a thickness of a pill packet, a location of the pill, and a distance between the pill packet and the discharge box 210.

Also, the apparatus includes an additional device for discharging a vacant pill packet with all pills discharged. A pushing bar 240 for discharging the vacant pill packet and a pushing bar driving unit 230 for transferring the pushing bar 240 are provided below the cylinder assembly 250.

The pushing bar 240 and the pushing bar driving unit 230 are disposed in one side of the guide bars 220. When the pushing bar driving unit 230 operates, the pushing bar 240 may be transferred to be closer to or distant from a pill packet on the guide bars 220. Also, it is necessary to determine locations of the pushing bar 240 and the pushing bar driving unit 230 not to collide with the guide bars 220 when the pushing bar 240 is closer to the pill packet.

When the pushing bar driving unit 230 operates and the pushing bar 240 pushes a pill packet, the pill packet may be discharged outward through the second outlet 170 of FIG. 2. When it is determined that all pills in the pill packet are discharged, the control unit of the apparatus 100 operates the pushing bar driving unit 230 to discharge the vacant pill packet outward by using the pushing bar 240 and allows the pushing bar 240 to return to an original location thereof after discharging of the vacant pill packet is completed.

In the configuration as described above, after a user allows a pill packet including pills to be contained in the containing unit 380, it is unnecessary to take an additional step to remove a vacant pill packet left after all pills therein are discharged. Merely, the pill discharged through the first outlet 160 may be taken and the vacant pill packet discharged through the second outlet 170 may be thrown away.

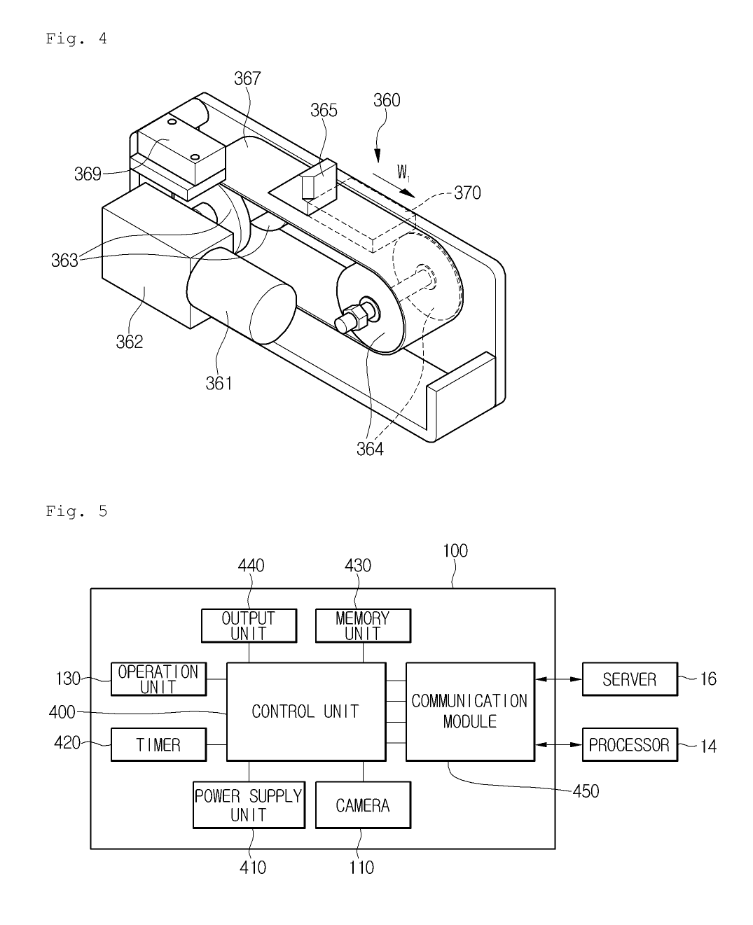

FIG. 5 is a block view illustrating the apparatus 100. Referring to FIG. 5, a method of providing a pill in the apparatus 100 and a method of transmitting and receiving data between the apparatus 100 and the processor 14 will be described in more detail.

Referring to FIG. 5, the apparatus 100 includes a power supply unit 410, a timer 420 for adding up times of taking pills, a memory unit 430 for storing information of taking pills, the operation unit 130 for setting an operation state of the apparatus 100, an output unit 440 for outputting a warning message related to taking pills to the user, and a control unit 400. Also, the camera 110 for taking pictures of the user taking pills and the taken pills to the network-connected server 16 or processor 14 is further included.

The timer 420 may add up elapsed time from when power is applied to the apparatus 100 or a predetermined setting is performed by the operation of the operation unit 130.

Also, the memory unit 330 may store information with respect to taking pills of a user taking the pill, that is, information on a point in time of taking a pill and information on checking whether the user takes the pill or not.

On the other hand, when the user goes out or stays out overnight and returns after the point in time of taking pills, to prepare for such case, a compulsorily discharging function may be provided.

That is, although the point in time of taking pills does not elapse, to manually operate the apparatus 100, when the user presses the operation unit 130 for longer than a preset time, an operative dose of pills may be discharged according to a taking order.

The output unit 440 may include at least one of the speaker 120 and the display unit 140. The warning message outputted through the output unit 440 may include a message informing that it is time to take a pill or a message informing that it is not the time to take the pill when the user operate the operation unit 130 when it is not the time to take the pill.

The warning message may be outputted periodically or repetitively before discharging pills.

The apparatus 100 may further include a communication module 450. The communication module 450 may receive information related to the operation of the apparatus 100 from the server 16 or the processor 14 or may transmit an image photographed by the camera 110 to the server 16 or the processor 14.

When the cylinder assembly 250 is operated, the control unit 400 determines that a pill is discharged through the first outlet 160 and allows the camera 110 to be on standby to photograph an image of the user taking the pill. To more definitely determine whether the user is in front of the camera 110 or not, the apparatus 100 may include a proximity sensor such as an infrared sensor. Accordingly, the control unit 400 photographs the image of the user taking the pill by using the camera 110 after driving the cylinder assembly 250.

Also, the control unit 400 provides the photographed image to the server 16 or the processor 14 via the communication module 450. After that, the control unit 400 may wait a command signal transferred from the server 16 or the processor 14, and when the command signal is received via the communication module 450, may transfer a warning message or a guide message to the user according to the corresponding command signal.

Also, the control unit 400 may change a schedule of taking pills such as changing a point in time for discharging a pill or changing a number of pills to be discharged according to the command signal transferred via the communication module 450. For example, when a doctor or an expert determines a condition of the user to be good, a command for reducing the number of pills to be taken is transferred from the server 16 or the processor 14. In this case, the control unit 400 may control the number of driving cylinders operated in the cylinder assembly 250.

Through the method as described above, the user may receive a care with respect to taking pills remotely. Also, when taking a pill, it is unnecessary to have a trouble of throwing away a vacant pill packet after taking the pills.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for providing a pill, the apparatus comprising:
a body forming an external shape;
a containing unit for containing a pill packet comprising pills to be taken;
a driving assembly provided below the containing unit and applying a force for pushing the pill packet in one direction;
a guide bar for providing a transfer path of the pill packet transferred by an operation of the driving assembly;
an elevation bar provided above the guide bar and capable of descending or ascending toward the pill packet;
a cylinder assembly for allowing the elevation bar to elevate;
a discharge box for containing the pills when the pills are separated from the pill packet by the elevation bar; and
a first outlet to be an opening of the discharge box.

2. The apparatus according to claim 1, further comprising:
a second outlet formed above the first outlet;
a pushing bar located in one side of the guide bar; and
a pushing bar driving unit for applying a force to the pushing bar to allow the pushing bar to transfer the pill packet toward the second outlet.

3. The apparatus according to claim 2, further comprising:
a control unit controlling operations of the cylinder assembly and the pushing bar driving unit;
a camera provided in one side of the body; and
a communication module for transferring an image photographed by the camera to a network-connected server or computer.

4. The apparatus according to claim 3, wherein the control unit controls the operations of the cylinder assembly and the pushing bar driving unit according to a signal received via the communication module.

5. The apparatus according to claim 4, wherein the cylinder assembly comprises a cylinder box, one or more driving cylinders partially contained in the cylinder box, and one or more elevation bars elevating according to operations of the driving cylinders.

6. The apparatus according to claim 5, wherein numbers and locations of the elevation bars and the driving cylinders correspond to a number and locations of the pills in the pill packet.
